(19) United States
(12) Patent Application Publication
(10) Pub. No.: US 2012/0311029 A1
(43) Pub. Date: Dec. 6, 2012

(54) COMMUNICATION SYSTEM

(75) Inventors: Rolf Schuster, Newbury (DE); Stefan Holtel, Aying (DE); Alex Phillips, Winchester (GB); David Barker, Winchester (GB); Jochen Kappel, Winchester (GB); Gareth Jones, Newbury (GB); Gavin Astur, Winchester (GB); Andy Strowbridge, Winchester (GB); Sima Nadler, Winchester (GB)

(73) Assignees: INTERNATIONAL BUSINESS MACHINES CORPORATION, Armonk, NY (US); VODAFONE GROUP PLC, Berkshire (GB)

(21) Appl. No.: 13/058,064

(22) PCT Filed: Aug. 7, 2009
(86) PCT No.: PCT/GB09/50988

§ 371 Date: Feb. 23, 2012

(30) Foreign Application Priority Data
Aug. 8, 2008 (GB) 0814537.7

(51) Int. Cl. G06F 15/16

(52) U.S. Cl. 709/204

(57) ABSTRACT

An apparatus for initiating a communication across a telecommunications network, the communication being between members of a social network, comprising means for retrieving data associated with a first subscriber from a social network server, the first subscriber being a member of the social network, the data including contact information for members of the social network associated with the subscriber, means for storing the contact information on a network server, means for providing the contact information to the subscriber, means for receiving selection of contacts with whom the subscriber wishes to initiate a communication, means for receiving selection of the type of communication with which the subscriber wishes to initiate communication with the selected contacts, and means for initiating a communication with the selected contacts across a telecommunication network.

The present invention relates to a communication system and in particular to a communication system which enables a member of a social network to communicate with his contact over a communication network.

In many countries computers have become commonplace in both the work place and at home. Additionally, for those who do not have access to personal computers, public access to computers is often available through ‘internet café’ type facilities in which members of the public can pay for access to computers provided by third parties for a particular time period. Therefore, a large proportion of the general public now have access to computer systems.

In recent years there have been large developments in the general connectivity between computers throughout the world. Internetworks, for example the Internet, now provide computers with the ability to connect to other computer systems and servers across the world over communication networks. Typically, in order to gain potential access to the internet a computer only needs to have a connection to a communication network. In particular, existing fixed line communication systems carry Internet traffic. Recently, the development of mobile communication networks has facilitated the transmission and receipt of internet data traffic over the air. Similarly, mobile telephone devices, as well as mobile devices generally, have been developed which include suitable hardware and software to connect to the internet via the over the air radio. This has provided many mobile computer and mobile phone users with the ability to access the internet while on the move across an over the air connection as well as in the historical way of connecting to a fixed communication line at a fixed location.

The accessibility of computer systems, development of the internet and improvement of mobile networks has resulted in members of the public being provided with access to internet and, hence, many of the applications and services provided over the internet for an increasing proportion of their time. Consequently, internet based applications have become a convenient way for many to keep in touch.

Widescale access to internet services has, in recent years, produced the emergence of many social networking sites, for example Facebook. These social networking sites enable subscribers to place information about themselves and their lives into a servers and databases which can be accessed through the site by other subscribers. Social network sites can allow all types of digital data to be stored and accessed and displayed to subscribers, including text, photos, video or audio files. In many cases subscribers are able to restrict access to their information to specific pre-approved subscribers, for example their friends or family. These pre-approved subscribers are known as ‘contacts’ since they are people with whom the subscriber has some level of contact. Each subscriber has a contact list associated with him. Social networks also allow members to send messages directly through the social network site. Therefore, when their contacts sign on to the site they are able to retrieve any messages sent to them through the social network site as well as access certain data from their contacts' storage areas within the network.

Social networks now play a central role in the lives of many people. Largely, the benefits are seen as being able to easily keep in touch with contacts regardless of where those contacts are located and to be able to share information with many people in one go, rather than having to send individual messages separately to each contact. The information shared between subscribers is often rich in nature including video and audio data. Social network sites are also seen as group facilities.

Despite the advantages of social network sites, messages and content only reach the recipient once that recipient signs onto the site. If the receiving party does not sign on to the site, he will never receive the message. While many individuals many sign on to their social networking sites regularly, the social network environment is not seen as a real time, two-way, communication facility. Therefore, the ease of use of content distribution provided by on-line social networks is often lost when a subscriber wishes to provide one or more contacts with real time receipt of information or engage one or more contacts in real time, two-way, communication since the recipient subscribers may not currently be signed onto the site. Additionally, communications are restricted to members of the social network. Therefore, if a subscriber wants to share content with five friends and two of these are not subscribed to the social network, he would have to distribute the content to those two non-subscribers through in a different way and would, perhaps, decide against sharing that content with them.

In recent times, the improvement of mobile telecom networks and the penetration of mobile communication devices among the public has increased to the stage where very high percentages of the population of, at least in many developed countries, own a mobile communication device. Additionally, in many developing countries, mobile communication networks are being deployed before fixed line networks and so mobile communication is a fundamental part of the infrastructure of some geographical areas of those countries. Such devices are also increasing in their capabilities. For example many devices are now able to handle different types of data such as video in addition to voice traffic.

Consequently, mobile communications devices are now recognised by many as their primary communication device. Typically, the devices are carried by the owner at most times and are available for real time and two-way communication involving voice and other types of data. However, such devices are largely recognised as being useful for communication between two parties rather than for group communication or for group data sharing.

We have appreciated that on-line social networks provide a straightforward way for subscribers to share information with contacts and, in particular, to share information or data between groups of contacts. However, such social networks are not ideal for engaging in real time communications since it may be some time before the target contacts sign onto the system and retrieve the communication. Additionally, content shared through social networks can often only be received by other subscribers to that network.

Mobile communication devices are now held by a large proportion of the population of many countries and allow people to be accessible at all times. Therefore, they have come to be recognised as the most appropriate tools for real time communication. However, initiating communications with groups of contacts and accessing content for sharing can be tedious.

Embodiments of the present invention overcome these problems by providing subscribers to on-line social networks with the ability to transmit communications to their social network contacts across communication networks outside the social network. Such embodiments benefit from the ease of use of an on-line type social network system along with the rich content available from the social network with the benefit of communicating with contacts through a communication channel which the contact may be more likely to receive in real time.

The invention is defined in its various aspects in the claims to which reference should now be made.

A specific embodiment is now described with reference to the accompanying figures, in which:

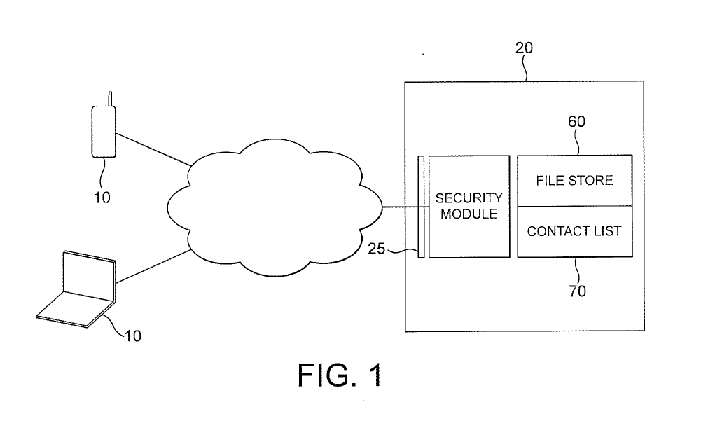

FIG. 1 is a block diagram showing elements of an on-line social networking environment;

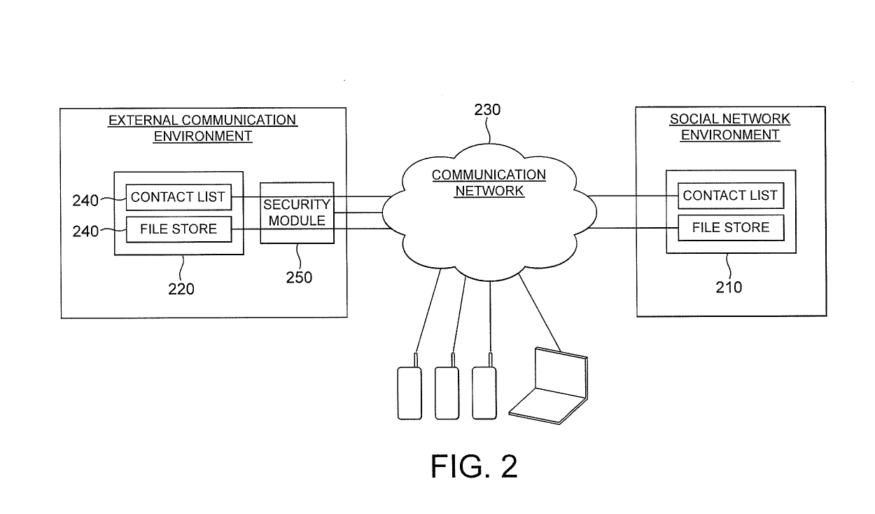

FIG. 2 is a block diagram showing the interaction between the servers of a social network site and an external communications application and a billing module;

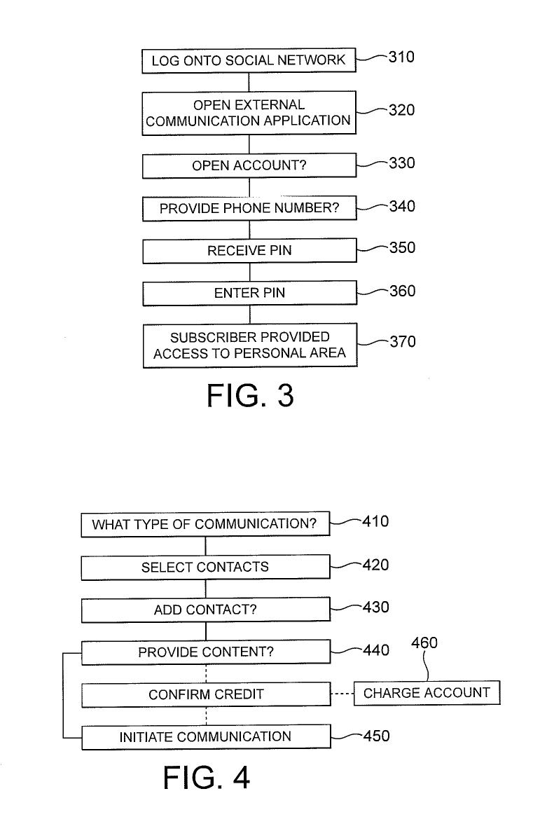

FIG. 3 is a flow diagram showing the steps taken when subscribing to an external communications application;

FIG. 4 is a flow diagram showing steps taken when requesting a data communication through an external communication application;

FIG. 1 shows the basic elements of an on-line social networking environment 20. A user is able to access the front page of the site 25 via a network connection which may be provided from a computer or mobile communication device 10. Each subscriber is allocated an area of storage within the social network environment in which he is able to store content. Such content is typically stored on a server 60. The content may be created directly on the site or may be uploaded by the user across the network. Examples of different content types include photographs or text. Certain social networking sites allow different types of data including video or audio files to be stored on their servers and be accessible through the site.

One of the fundamental elements of the social networking site is the contact list 70. Each subscriber creates his own personal contact list including other subscribers. The contact list will include other subscribers with whom the subscriber may wish to contact or with whom he may wish to share his content. The subscriber can store contact information against that contact, for example e-mail address or social network ID. In order to get maximum benefit from the contact status, contacts can be linked together in a manner which allows content to be shared between them or in a manner which gives the subscriber visibility of his contact's content and vice versa.

Typically, in order to link subscribers together, a first subscriber will identify that he wishes a second subscriber to become his contact. The social networking site will then indicate to the second subscriber that the first subscriber wishes the second subscriber to become his contact and invites the second subscriber to approve the first subscriber's request. The response from the second subscriber will then determine the level of access to each subscriber's content provided to the other subscriber by the social networking site. Examples of different accesses may include, for example: a) the subscriber may refuse the request in which case the first subscriber would be unable to access any content in the second subscriber's area except that which he has made fully publically available; b) the second subscriber may grant full access to the first subscriber to all content in his area; or, c) the second subscriber may restrict access to certain content but grant access to other content in his area.

Once a subscriber has responded to a contact request, the social network identifies that access rights, in whatever form, have been granted between the subscribers and this access right is stored against the profile of the subscriber. The social network then manage the security around any content placed in the subscribers' areas in order that access is provided as required by the subscribers.

Social networks operate, typically, by subscribers selecting their contacts and viewing content that their contacts have entered onto their area. This enables the contacts to share information and content with each other. Contacts may also send messages to each other via the social networking site which appear in their area next time they log onto the system.

The social networking site typically provides security restrictions to each subscriber's area by requiring personal identification information to be provided before granting the subscriber access to their area.

As discussed above, social networking sites provide subscribers with the facility to easily keep in touch with multiple contacts who are also subscribers to the social network. The fact that the communication is typically done on a pc based environment makes the user interface easy to use and is attractive to many subscribers.

FIG. 2 shows the basic architecture of a system in which subscribers to a social network are provided with the facility to initiate communications outside of the social network environment. Social networking server 210 is connected to an external communication server 220 which exists outside of the social networking environment. The external communication server is connected to at least one communication network 230 and is able to initiate communications across those networks. The external communication server also has storage capacity for storing data including data files and contact information 240 and a security module 250.

The social network site provides its subscribers with a link to the external communication server to allow them to make communications outside the social network environment. Any social network subscriber who wishes to initiate communications to be received in an environment outside the social network is able to create an account with the external communication server. The subscriber will then be allocated a specific storage area within the external communications server for storage of his own data.

The external communications server and the social network server are connected across a network in such a way that the subscriber is able to transfer data from his personal area on one server to his personal area on the other server. Such data may include details of his contacts as well as file content, for example pictures or video.

From a security perspective, it is important that the subscriber's areas in the two servers are linked together securely in order that data cannot be accessed or retrieved by persons other than the subscriber himself. FIG. 3 is a high level flow diagram showing the sign on process for a subscriber to the social network who wishes to create an account in the external communications server. At 310, the subscriber gains access to his area in the social network by opening up the URL of the social network and by entering his personal identification information. At this stage he is provided with access to all content in his personal area.

The application for external communications is accessible from the social networking site. Typically, the social networking site will include a URL link to the external communications application. On selecting the external communications application, the social network site will create a communication link through to the external communications application at 320. The subscriber will then be invited to open an account with the external communications application at 330. Since the user is already logged into the social network, the social network is able to pass a user ID across to the external communication application to map to the area created for the same subscriber within the external communication environment. The external communication server then allocates a specific personal identification information to the subscriber. In preferred embodiments of the invention, this is provided to the subscriber via an SMS message to his communication device. Therefore, the subscriber will be invited to enter his contact number into the external communication application at 340. At 350 the external communication application forwards to the subscriber his personal identification information. Preferably, this is forwarded via a SMS message for a subscriber having a mobile communication device.

At 360, the subscriber is prompted to enter his personal identification information into the external communication server in order to access his area at 370. Thus, the subscriber is recognised by the external communications application by his contact number along with his personal identification information. In future visits to the application, the subscriber is able to gain access to his area by providing these two pieces of information.

The subscriber is now authorised access to his account on the external communication application as well as on the social network application. Typically, both applications will share passcodes which are specifically associated with that subscriber in order to allow the sharing of data between the subscriber's accounts. These passcodes can be presented by the application each time that application requests content from the account of the subscriber within the other application in order to authorise that transfer of content.

Once the subscriber has created an area in the external communication application he is able to populate the area with contacts and content. Contacts from the social network can be uploaded directly from the social network. This is performed by the external communication application interrogating the social network for contacts of the subscriber. In order to meet the security provisions of the system, the external communication application will present information relating to the subscriber to the social network in order that the social network can confirm that the requesting party is the same subscriber.

The first time the subscriber attempts to populate his contacts into the external communication application, the external communication application includes no entries. Therefore, all of the contacts from the social network will need to be copied into the external communication application. The details of these contacts are then provided to the external communication application and stored in the storage area allocated to the subscriber. In future interrogations, the external communication server will already have contact information stored and so the system will look for any contact information in the social network which is additional or different from that in the external communication application and will only transmit those updates in order to bring the contact details stored in the external communication server into line with that stored in the social network server. Known applications and protocols, for example Sync ML, are used for comparing data between two databases and identifying any differences between those data sets and any such comparison application or protocol can be used in embodiments of the invention to compare the data in the different databases and identify and transmit any updated data to the other database. Such protocols may operate by comparing the data or, alternatively, by recording the time at which an update or comparison is made and recording the time at which any change is made to data in the server. Thus, next time a comparison request is made, the system identifies any changes which have been made at times after the last comparison and simply forwards those changes to the other server.

In preferred embodiments of the invention, the contacts within the social network server are deemed to be the most up to date contacts and so the external communication server will always look to place its contact list into the same form as that stored on the social network. In such embodiments, if contact details have been changed or added in the external communication server these changes will not be transferred into the social network server. In alternative embodiments of the invention, the system is arranged simply to synchronise the databases. In such embodiments updates which have been made to either database since the most recent comparison are updated in the other server. In preferred embodiments of the invention, the social network database is interrogated for updates to contact information when the subscriber signs on to the external communication site. However, in further embodiments, the interrogation may be triggered periodically and automatically, the subscriber may be prompted to interrogate or the subscriber may prompt the system manually each time he wants to synchronise his contacts in his external communication site with those on his social network. Once contacts are loaded into the external communication server, the subscriber is able to initiate communications via that server.

Within the external communication server contact list, the subscriber is, typically, asked to confirm a preferred contact number for each of the contacts. Preferred embodiments of the invention enable the subscriber to specify different contact numbers for communications made at different times of day or the week. For example, the subscriber may identify that during the hours of 9 am to 6 pm between Monday to Friday the contact is likely to be in the office and so he may specify a work contact number. For all other times of day the subscriber may identify a personal phone number for that subscriber. Additionally, the subscriber may identify different contact numbers for a contact for different types of communication. For example, if the subscriber wishes to send a Short Message Service message (SMS) or Multimedia Message Service (MMS) to the contact he may prefer that the communication is transmitted to the mobile telephone of the contact which is capable of rendering the content of the message. In contrast, if the subscriber wishes to send voice communication to a contact his preference may be the contact's fixed line telephone.

Preferably, once the subscriber has signed into the external communication site and has been authorised by the social network site, he is provided with full rights to amend his contact data by, for example adding contacts or contact information or changing contact information. Additionally, further embodiments of the invention allow the subscriber to add contact information which is only retained for the duration of the session. Such contact information is deleted from the subscriber's account once the external communication session is completed.

FIG. 4 is a flow diagram showing the steps taken in order to set up a communication from the external communication server. Initially, the subscriber selects what type of communication he wishes to make at 410. Examples of types of communications which may be allowed include voice call, conference call, SMS and MMS. In certain embodiments of the invention, only certain modes of communication may be allowed, for example SMS and MMS only. In other embodiments additional types of communication may be allowed beyond those mentioned above. In certain embodiments of the invention, the type of account which the subscriber holds may determine the type of communications that he is permitted to make. For example a gold account might allow any type of communication, whereas a bronze account may only allow SMS messaging.

The subscriber then selects which contacts he wishes to include in the communication at 420. Preferred selection methods may be a checkbox against the contact's profile on the site. The subscriber may be invited to add additional new contact details for a contact he wishes to include in the communication at 430. If the system is one in which the subscriber is able to select different contact numbers or forms for individual contacts, the system then selects the appropriate contact number for the current time of day or type of communication.

If the type of communication requested by the subscriber requires additional content, for example SMS or MMS message, the subscriber provides this at 440. Different embodiments of the invention may provide this functionality in different ways. For example, for an SMS message, the external communication site may provide a text window into which the subscriber may enter text or characters from his keypad. If the subscriber wishes to send a MMS message the subscriber may be able to upload these from his computer or mobile communication device directly onto the external communication server over the internet. Alternatively, the subscriber may be able to share content from his social network site, for example pictures, video or audio, onto his external network site and select this content for transmission to the selected contacts.

In the event that the subscriber wishes to initiate a voice call, whether two way or with multiple parties over a conference bridge, he selects that option within the site.

Once the subscriber has completed the steps of selecting the contacts for receipt of the communication and selecting the type of communication and the content of that communication, he confirms that the communication should be initiated at 450.

Preferred embodiments of the invention include a mechanism by which subscribers are required to pay for the external communication service in some way, for example by charging an account or by gaining payment tokens by some other means. Details of the charging modules are provided in detail below. If the system requires the subscriber to pay for the service, the subscriber's account is then charged at 460. The account may be a pre-pay credit account in which the subscriber purchases credit and this is reduced as the subscriber uses the service. In such embodiments, the system checks the status of the subscriber's account before confirming that the communication can go ahead. If the subscriber has sufficient credit, the account is debited and the communication is continued. If the subscriber's account does not hold sufficient credit, the subscriber is informed and the communication can not be initiated until the subscriber's account is replenished. If the subscriber is on a post-pay account, for example if he is provided access to the service and is presented with an invoice after using the service, the communication activity is logged against his account to be charged at a later stage.

Once the system has accounted for any cost charging, the system attempts to complete the communication. At this stage, the server forwards the communication to a communication network to complete the communication.

If the communication includes content, for example SMS or MMS data, this data is provided to the network along with the contact numbers of the selected contacts to which the message should be sent. The network then distributes the communications in the normal way. In preferred embodiments of the invention, if the system recognises that the communication is required to be placed into a format which is suitable for distribution it will reformat the content for appropriate distribution. This may be performed before the content and contact details are passed to the network. For example, if a picture is being sent to a number of mobile telephones, the system could reformat the picture into a form which will be suitable for rendering on a mobile telephone.

In preferred embodiments of the invention the system allows the contact details of the subscriber to be provided to all of the recipient contacts. In such embodiments, the external communication server provides the contact details of the subscriber to the network, for example the MSISDN of the subscriber. When the network transmits the communication to the recipient contacts they are able to add in the subscriber's MSISDN in order that, on receipt of the communication, the communication appears to have initiated from the subscriber's device. Thus, on a typical mobile communication device, if the recipient contact wishes to reply, he will reply directly to the subscriber's mobile telephone defined by his MSISDN which is visible to the recipient contact.

Additional information about the subscriber may be included in the communication. For example, the URL of the subscriber's social network account might be included in the communication. Therefore and recipient contact could access the URL in order to access the public area of the subscriber's social network account. Such embodiments are particularly useful for, so called, viral advertising in order to obtain traffic through those social networks and increasing awareness and membership.

If the subscriber has selected to initiate a group conference call, once the system has determined that it will initiate the communication, it passes the request to initiate a conference call to the network along with the contact details of all contacts as well as the contact details of the subscriber himself. The network then allocates a specific conference bridge to the communication. In preferred embodiments of the invention, the network sets up the conference bridge and then dials each of the selected contacts into the conference bridge. Therefore, the network calls each of the selected contacts, as well as the subscriber initiating the conference. When the contacts and subscriber answer their telephones the network enters them directly into the conference bridge. In preferred embodiments of the invention, the network provides a short audio introduction to each of the participants before placing them into conference in order to confirm that they have been invited to participate in a conference call.

Preferred embodiments will also identify the subscriber who invited them to participate.

In alternative embodiments, the network sends the conference call invitation to each participant via a SMS message. The SMS message includes the telephone number of the conference bridge allocated to the conference bridge as well as any authorisation codes required to gain entry into the conference bridge. The SMS may also include information identifying the subscriber who is initiating the conference. The participants then have the option whether or not they wish to join the conference by dialling in. Additionally, when setting up a conference bridge in this way, the subscriber may have an opportunity to include a SMS message along with the conference invitation.

There are a number of ways in which the application might charge its subscribers for the external communication service. For example, the application might prompt them to enter their bank account details and charge them directly for using the service. However, a preferred method is to charge subscribers indirectly through their network providers' accounts. When a subscriber subscribes to the service he is asked to enter his contact details number, for example his MSISDN. This number is then used as his contact number in the case of establishing voice calls or is presented to the contacts when the subscriber requests an SMS or MMS to be transmitted to his contacts. In addition to entering his communication number, when a subscriber subscribes to the application he is also asked to provide the details of the network operator to which he subscriber, for example his mobile network operator. The application may then run a security check on the subscriber with his network operator. Once the application has approved the subscriber through the network operator, it informs the network operator that their customer has subscribed to the application and establishes a billing relationship with the network operator. Whenever the subscriber requests additional credit on their account, the external communication application invoices the network provider who, subsequently, invoices their customer.

It will be clear to those skilled in the art that embodiments of the present invention provide the benefits of the social networking contact list along with the ability to communicate with those contacts outside the social network environment by providing access to additional communication networks, for example mobile communication networks. Embodiments of the invention also allow subscribers to social networks to communicate with, and share content with, friends who are not part of the social network community in the same action as those contacts who are part of the social network community.

1: A method for initiating a communication across a telecommunications network, the communication being between members of a social network, comprising the steps of:
retrieving data associated with a first subscriber from a social network server, the first subscriber being a member of the social network, the data including contact information for members of the social network associated with the subscriber;
storing the contact information on a network server;
providing the contact information to the subscriber;
receiving selection of contacts with whom the subscriber wishes to initiate a communication;
receiving selection of the type of communication with which the subscriber wishes to initiate communication with the selected contacts;
initiating a communication with the selected contacts across a telecommunication network.

2: The method of claim 1 wherein the type of communication is a data communication and comprising the further steps of retrieving content from the social network and including the content in the communication.

3: The method of claim 1 including the further step of receiving contact information for non-members of the social network.

4: The method of claim 1 comprising the further step of including the contact details of the subscriber with the initiated communication.

5: The method of claim 1 wherein the telecommunication network is a mobile telecommunication network.

6: An apparatus for initiating a communication across a telecommunications network, the communication being between members of a social network, comprising:
means for retrieving data associated with a first subscriber from a social network server, the first subscriber being a member of the social network, the data including contact information for members of the social network associated with the subscriber;
means for storing the contact information on a network server;
means for providing the contact information to the subscriber;
means for receiving selection of contacts with whom the subscriber wishes to initiate a communication;
means for receiving selection of the type of communication with which the subscriber wishes to initiate communication with the selected contacts;
means for initiating a communication with the selected contacts across a telecommunication network.

7: The apparatus of claim 6 wherein the type of communication is a data communication and further comprising means for retrieving content from the social network and including the content in the communication.

8: The apparatus of claim 6 further comprising means for receiving contact information for non-members of the social network.

9: The apparatus of claim 6 further comprising means for including the contact details of the subscriber with the initiated communication.

10: The apparatus of claim 6 wherein the telecommunication network is a mobile telecommunication network.
